(19) United States
(12) Patent Application Publication
(10) Pub. No.: US 2014/0053533 A1
(43) Pub. Date: Feb. 27, 2014

(54) REVERSE FLOW GAS TURBINE ENGINE WITH THRUST REVERSER

(71) Applicants: Gabriel L. Suciu, Glastonbury, CT (US); Jesse M. Chandler, South Windsor, CT (US)

(72) Inventors: Gabriel L. Suciu, Glastonbury, CT (US); Jesse M. Chandler, South Windsor, CT (US)

(21) Appl. No.: 13/590,223

(22) Filed: Aug. 21, 2012

(51) Int. Cl. F02K 1/56; F02K 3/06

(52) U.S. Cl. 60/226.2

(57) ABSTRACT

A gas turbine engine has an outer housing defining an exit nozzle at a downstream end of the engine. A fan is mounted at an upstream end of the engine, and rotates on a first axis. The nozzle is centered on the first axis. A core engine includes a compressor section, a combustor and a turbine section. The turbine section is closest to the fan, the combustor section and then the compressor section and positioned further away from the fan relative to the turbine section. A downstream end of the nozzle has at least one pivoting shell and an actuator to pivot the at least one shell between an in-flight position and a deployed position in which the at least one shell inhibits a flow cross-sectional area of said nozzle to provide a thrust reverser.

### BACKGROUND OF THE INVENTION

This application relates to the inclusion of a thrust reverser at a rear end of a gas turbine engine which utilizes a reverse flow concept.

Gas turbine engines are known, and typically include a fan delivering air into a compressor section and also outwardly of the compressor as bypass air. Air from the compressor section passes into a combustor, is mixed with fuel, and ignited. Products of this combustion pass downstream over turbine rotors, driving them to rotate.

One recently developed type of gas turbine engine is a so-called “reverse flow” gas turbine engine. In typical gas turbine engines, the fan is positioned axially at an end of an engine, and then the compressor, combustor and turbine section are placed in that order. In a reverse flow gas turbine engine, the turbine is adjacent the fan, and the combustor is at an inner end of the turbine, with the compressor positioned even more inwardly.

A thrust reverser is utilized once an aircraft carrying the gas turbine engine has landed, and acts to create a reverse force to slow the aircraft.

One concept that has been proposed in gas turbine engines is a thrust reverser provided by pivoting shell halves at the rear of a nozzle. Such thrust reversers were generally utilized in prior gas turbine engines which used little, or no, bypass air.

In addition, various types of thrust reversers have been incorporated into more modern gas turbine engines which do have a large fan providing bypass air as propulsion, and in addition to the air passing through the compressor. However, this standard type of gas turbine engine generally had an engine core that extended beyond the end of the nozzle, such that the shell halves could not pivot inwardly to a thrust reverse position.

### SUMMARY OF THE INVENTION

In a featured embodiment, a gas turbine engine has an outer housing defining an exit nozzle at a downstream end of the engine. A fan, mounted at an upstream end of the engine, rotates on a first axis. The nozzle is centered on the first axis. A core engine has a compressor section, a combustor and a turbine section. The turbine section is closest to the fan. The combustor section and then the compressor section are positioned further away from the fan relative to the turbine section. A downstream end of the nozzle has at least one pivoting shell and an actuator to pivot the at least one shell between an in-flight position and a deployed position in which the at least one shell inhibits a flow cross-sectional area of the nozzle to provide a thrust reverser.

In another embodiment according to the previous embodiment, the core engine is positioned on a second axis. The first axis and second axis are non-parallel.

In another embodiment according to any of the previous embodiments, there is a pair of pivoting shells.

In another embodiment according to any of the previous embodiments, each of the shells are driven by a linkage to move between the in-flight flight position, and the deployed position at which a reverse thrust is created.

In another embodiment according to any of the previous embodiments, the linkages are mounted within fixed portions of the nozzle, which are circumferentially intermediate the pivoting halves.

In another embodiment according to any of the previous embodiments, the fixed portions of the nozzle include a downstream end of the shells.

In another embodiment according to any of the previous embodiments, a downstream end of the shell has a curved surface that is received within a mating curved surface in the downstream end of the fixed portions of the nozzle.

In another embodiment according to any of the previous embodiments, the fan delivers air into the compressor section, but also delivers bypass air to the nozzle.

In another embodiment according to any of the previous embodiments, the fan delivers air into the compressor section, but also delivers bypass air to the nozzle.

In another embodiment according to any of the previous embodiments, the core engine is positioned on a second axis. The first axis and second axis are non-parallel.

In another embodiment according to any of the previous embodiments, each of the shells is driven by a linkage to move between the in-flight flight position, and the deployed position at which a reverse thrust is created.

In another embodiment according to any of the previous embodiments, the linkages are mounted within fixed portions of the nozzle, which are circumferentially intermediate the pivoting halves.

In another embodiment according to any of the previous embodiments, the fixed portions of the nozzle include a downstream end of the shells.

In another embodiment according to any of the previous embodiments, a downstream end of the shell has a curved surface that is received within a mating curved surface in the downstream end of the fixed portions of the nozzle.

In another embodiment according to any of the previous embodiments, the gas turbine engine further includes a fan drive turbine positioned downstream of the turbine section of the core engine and a gear reduction. The gear reduction is included between the fan drive turbine and the fan. The fan rotates at a slower speed than the fan drive turbine.

In another embodiment according to any of the previous embodiments, the core engine turbine section and the fan drive turbine are separate turbines.

In another embodiment according to any of the previous embodiments, the fan drive turbine rotates on the first axis.

In another embodiment according to any of the previous embodiments, the core engine is positioned on a second axis. The first axis and second axis are non-parallel.

In another featured embodiment, an aircraft has a gas turbine engine which includes an outer housing defining an exit nozzle at a downstream end of the engine. A fan mounted at an upstream end of the engine, rotates on a first axis. The nozzle is centered on the first axis. A core engine has a compressor section, a combustor and a turbine section, with the turbine section being closest to the fan. The combustor section and then the compressor section are positioned further away from the fan relative to the turbine section. A downstream end of the nozzle has at least one pivoting shell and an actuator to pivot the at least one shell between an in-flight position and a deployed position in which the at least one shell inhibits a flow cross-sectional area of the nozzle to provide a thrust reverser.

In another embodiment according to the previous embodiment, the core engine is positioned on a second axis. The first axis and second axis are non-parallel.

In another embodiment according to any of the previous embodiments, there is a pair of pivoting shells.

In another embodiment according to any of the previous embodiments, each of the shells are driven by a linkage to move between the in-flight flight position, and the deployed position at which a reverse thrust is created.

In another embodiment according to any of the previous embodiments, the fan delivers air into the compressor section, but also delivers bypass air to the nozzle.

In another embodiment according to any of the previous embodiments, the he aircraft further has a fan drive turbine positioned downstream of the turbine section of the core engine, and a gear reduction. The gear reduction is included between the fan drive turbine and the fan. The fan rotates at a slower speed than the fan drive turbine.

In another embodiment according to any of the previous embodiments, the core engine is positioned on a second axis. The first axis and second axis are non-parallel.

These and other features of this application will be best understood from the following specification and drawings, the following of which is a brief description.

### BRIEF DESCRIPTION OF THE DRAWINGS

FIG. 1 schematically shows a proposed aircraft with gas turbine engine mount locations.

FIG. 2 schematically shows a gas turbine engine in a thrust reverse position.

FIG. 3A is a cross-section through a reverse flow engine.

FIG. 3B schematically shows the positioning of certain structure within the gas turbine engine.

FIG. 4A shows a nozzle in a normal thrust position.

FIG. 4B shows a nozzle in a reverse thrust position.

### DETAILED DESCRIPTION

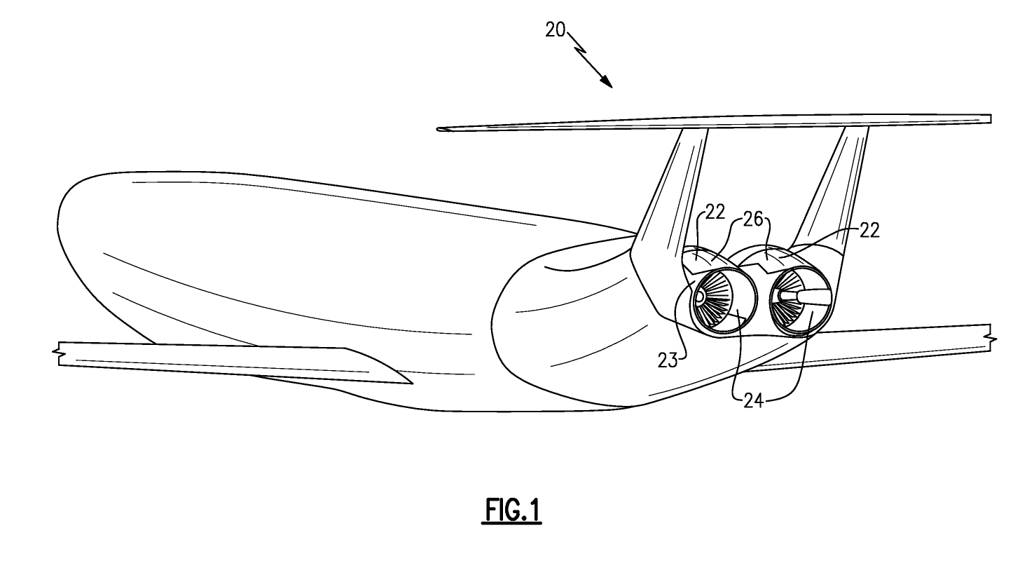

FIG. 1 shows an aircraft 20. This proposed future aircraft has engine mount locations for engines 22 between a portion of the tail. At these locations, there are certain positioning restrictions on the engine.

As shown, a nozzle 23 has shell halves 26 that can pivot, as will be explained below, to block the flow out of an exhaust exit area 24 of the engine 22.

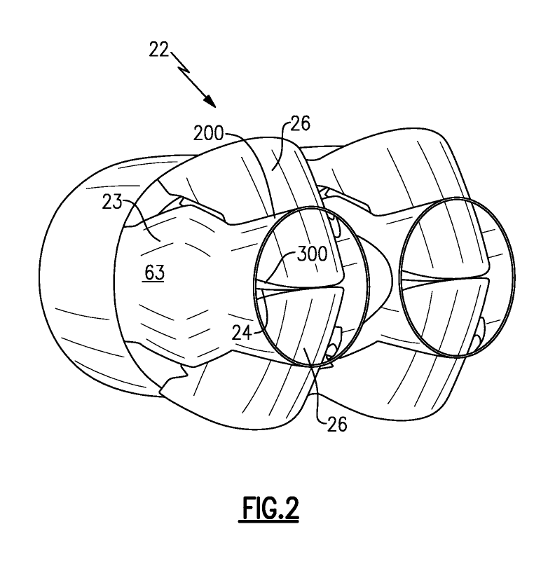

FIG. 2 shows the nozzle 23 having pivoting shell halves 26 that pivot to block the exit area 24. As can be appreciated from FIG. 2, a fixed portion 63 of the nozzle 23 includes a downstream end 200 which is downstream of a downstream end 300 of the shell halves 26. The downstream end 300 of the shell half is curved, as is a mating surface of the downstream portion 200 of the fixed housing portion 63. As should be understood, in this position, continued thrust from the engine will create a force resisting forward movement of the associated aircraft 20.

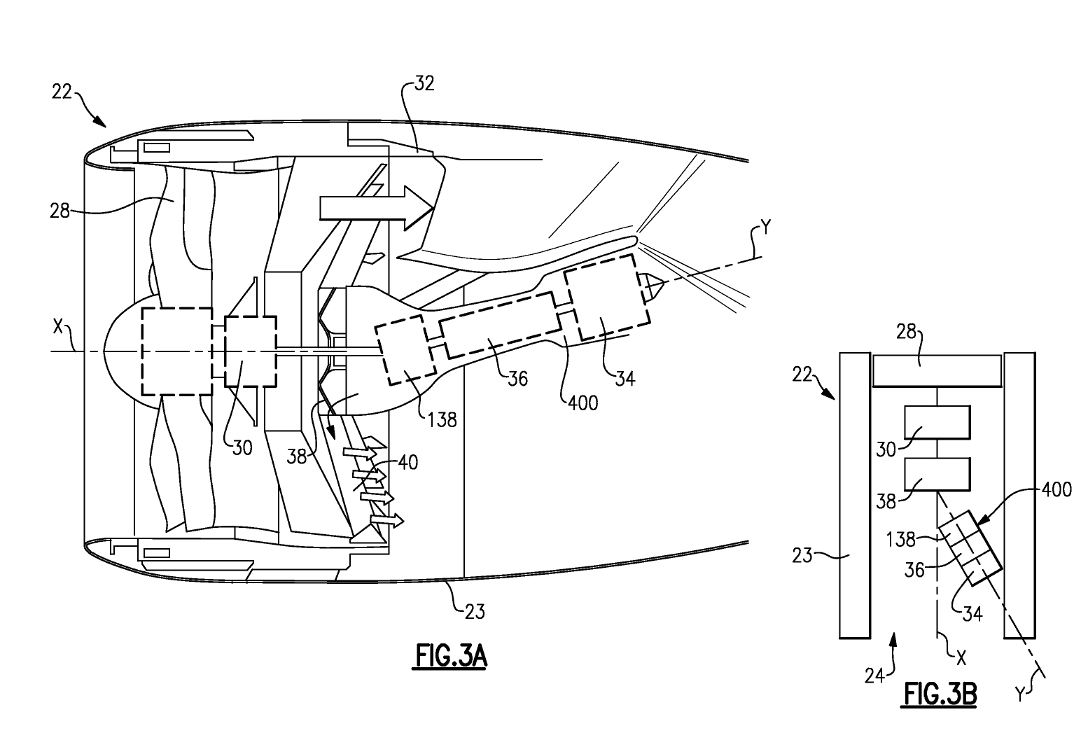

FIG. 3A shows an engine 22. Engine 22 includes a fan 28 at a forward end which is centered for rotation about an axis X. Axis X is also a central axis of the nozzle 23. A gear reduction 30 is driven by a turbine section 38 to drive the fan 28.

A core engine 400 includes combustion section 36 positioned between another turbine section 138 and a compressor section 34. Air passes into an inlet duct 32 to be delivered to the compressor 34. The duct 32 is over a limited circumferential extent. At other circumferential locations, air flows as bypass air for propulsion. The air is compressed and delivered into combustion section 36, where it mixes with fuel and is ignited. Products of this combustion pass over turbine section 138, which drives compressor section 34. The products of combustion then pass over turbine section 38, to drive the fan.

The illustrated jet engine is a “reverse flow engine” in that the compressor is positioned further into the engine than is the turbine 38.

As shown in FIG. 3B, the engine 22 is also positioned such that the fan 28, gear 30, and turbine 38 are positioned centered on axis X while core engine 400, including compressor 34, combustor 36, and turbine 138, is positioned on a non-parallel axis Y. The core engine is preferably mounted in some manner to the nozzle 23.

In an engine that is reverse flow, and in particular in one wherein the axes X and Y are not parallel, a relatively long core engine 34/36/138 can be achieved without the core engine blocking the exit area 24. Thus, with this engine arrangement, a thrust reverser utilizing the shell halves 26 can be incorporated.

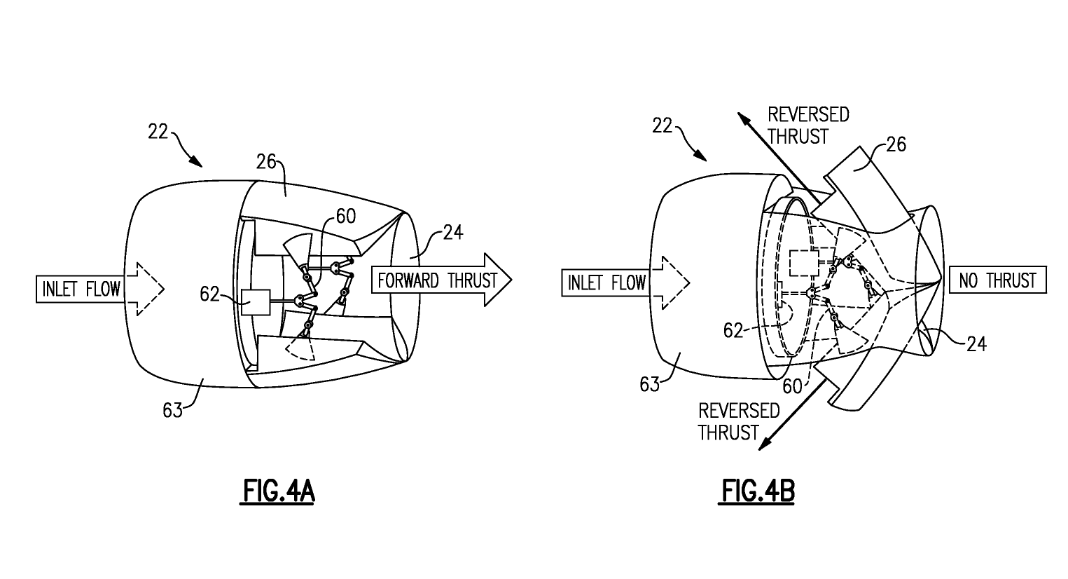

FIG. 4A shows the engine 22 having a linkage 60 driven by an actuator 62. Actuator 62 is fixed within fixed housing portion 63. The position illustrated in FIG. 4A is the normal flight position.

Once an aircraft associated with the engine 22 has landed, the actuator 62 drives the linkage 60 into a deployed position 60′ in which the shell halves 26 are pivoted to a deployed position (FIG. 4B) at which they block the exit area 24. The fan and turbine section continue to deliver exhaust gas against the deployed halves 26, and create a reverse thrust tending to slow the aircraft.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
an outer housing defining an exit nozzle at a downstream end of said engine;
a fan mounted at an upstream end of said engine, said fan rotating on a first axis, and said nozzle centered on said first axis;
a core engine, including a compressor section, a combustor and a turbine section, with said turbine section being closest to said fan, said combustor section and then said compressor section being positioned further away from said fan relative to said turbine section; and
a downstream end of said nozzle having at least one pivoting shell and an actuator to pivot said at least one shell between an in-flight position and a deployed position in which the at least one shell inhibits a flow cross-sectional area of said nozzle to provide a thrust reverser.

2. The gas turbine engine as set forth in claim 1, wherein said core engine is positioned on a second axis and said first axis and said second axis are non-parallel.

3. The gas turbine engine as set forth in claim 1, wherein there is a pair of said pivoting shells.

4. The gas turbine engine as set forth in claim 3, wherein each of said shells are driven by a linkage to move between the in-flight flight position, and the deployed position at which a reverse thrust is created.

5. The gas turbine engine as set forth in claim 4, wherein said linkages are mounted within fixed portions of said nozzle which are circumferentially intermediate said pivoting halves.

6. The gas turbine engine as set forth in claim 5, wherein said fixed portions of said nozzle include a downstream end of said shells.

7. The gas turbine engine as set forth in claim 6, wherein a downstream end of said shell has a curved surface which is received within a mating curved surface in said downstream end of said fixed portions of said nozzle.

8. The gas turbine engine as set forth in claim 6, wherein said fan delivers air into said compressor section, but also delivers bypass air to said nozzle.

9. The gas turbine engine as set forth in claim 1, wherein said fan delivers air into said compressor section, but also delivers bypass air to said nozzle.

10. The gas turbine engine as set forth in claim 7, wherein said core engine is positioned on a second axis and said first axis and said second axis are non-parallel.

11. The gas turbine engine as set forth in claim 9, wherein each of said shells is driven by a linkage to move between the in-flight flight position, and the deployed position at which a reverse thrust is created.

12. The gas turbine engine as set forth in claim 11, wherein said linkages are mounted within fixed portions of said nozzle which are circumferentially intermediate said pivoting halves.

13. The gas turbine engine as set forth in claim 12, wherein said fixed portions of said nozzle include a downstream end of said shells.

14. The gas turbine engine as set forth in claim 13, wherein a downstream end of said shell has a curved surface which is received within a mating curved surface in said downstream end of said fixed portions of said nozzle.

15. The gas turbine engine as set forth in claim 1, further comprising:
a fan drive turbine positioned downstream of the turbine section of the core engine; and
a gear reduction,
wherein the gear reduction is included between the fan drive turbine and said fan, and wherein the fan rotates at a slower speed than the fan drive turbine.

16. The gas turbine engine as set forth in claim 15, wherein said core engine turbine section and said fan drive turbine are separate turbines.

17. The gas turbine engine as set forth in claim 16, wherein said fan drive turbine rotates on said first axis.

18. The gas turbine engine as set forth in claim 17, wherein said core engine is positioned on a second axis and said first axis and said second axis are non-parallel.

19. An aircraft comprising:
a gas turbine engine comprising:
an outer housing defining an exit nozzle at a downstream end of said engine;
a fan mounted at an upstream end of said engine, said fan rotating on a first axis, and said nozzle centered on said first axis;
a core engine, including a compressor section, a combustor and a turbine section, with said turbine section being closest to said fan, said combustor section and then said compressor section being positioned further away from said fan relative to said turbine section; and
a downstream end of said nozzle having at least one pivoting shell and an actuator to pivot said at least one shell between an in-flight position and a deployed position in which the at least one shell inhibits a flow cross-sectional area of said nozzle to provide a thrust reverser.

20. The aircraft as set forth in claim 19, wherein said core engine is positioned on a second axis and said first axis and said second axis are non-parallel.

21. The aircraft as set forth in claim 19, wherein there is a pair of said pivoting shells.

22. The aircraft as set forth in claim 19, wherein each of said shells are driven by a linkage to move between the in-flight flight position, and the deployed position at which a reverse thrust is created.

23. The aircraft as set forth in claim 19, wherein said fan delivers air into said compressor section, but also delivers bypass air to said nozzle.

24. The aircraft as set forth in claim 19, further comprising:
a fan drive turbine positioned downstream of the turbine section of the core engine; and
a gear reduction,
wherein the gear reduction is included between the fan drive turbine and said fan, and wherein the fan rotates at a slower speed than the fan drive turbine.

25. The aircraft as set forth in claim 24, wherein said core engine is positioned on a second axis and said first axis and said second axis are non-parallel.
